(19) United States
(12) Patent Application Publication
(10) Pub. No.: US 2002/0042450 A1
(43) Pub. Date: Apr. 11, 2002

(54) Use of monodisperse ion exchangers for arsenic and/or antimony removal

(76) Inventors: G?uuml;nter Lailach, Krefeld (DE); Reinhold Klipper, K?ouml;ln (DE)

Correspondence Address: BAYER CORPORATION, PATENT DEPARTMENT, 100 BAYER ROAD, PITTSBURGH, PA, 15205, US

(21) Appl. No.: 09/971,887

(22) Filed: Oct. 4, 2001

(30) Foreign Application Priority Data
Oct. 9, 2000 (DE) 10049807.8

(51) Int. Cl. C08F 2/00

(52) U.S. Cl. 521/30

(57) ABSTRACT

The present invention relates to the use of monodisperse ion exchangers, particularly monodisperse anion exchangers or monodisperse chelating resins, for the selective removal of arsenic and/or antimony in the form of AsF₆⁻ ions or SbF₆⁻ ions from aqueous solutions.

### BACKGROUND OF THE INVENTION

The present invention relates to the use of monodisperse amino/ammonium-functionalized ion exchangers or of monodisperse chelating resins for the selective removal of arsenic ions or of antimony ions from aqueous solutions.

Many naturally occurring minerals have contamination by chemical elements that occur in considerable amounts in extraction processes and as undesirable ancillary product in the purification procedure for obtaining the actual chemical compound. One of these chemical elements is arsenic, present in fluorspar, for example, and occurring in the synthesis of hydrogen fluoride and another is antimony. The disposal of the arsenic-containing or antimony-containing production residues is very resource-intensive and cost-intensive, especially if these residues have come into contact with water and this water is to be passed back from process circulation systems into circulation in the environment.

DD 254 373 A1 discloses a process for obtaining high purity hydrofluoric acid, but here arsenic is treated by way of a heterodisperse ion exchanger with core thiol groups in H⁺ form.

WO 89/11321 describes a process for preparing hydrofluoric acid with an apparatus operated using not only an anion exchanger but also a cation exchanger, for example, in order to remove arsenic from the reaction medium. Preference is given to weakly basic anion exchangers, such as Dowex M-43® or Biorad AGW-W4A®, but Amberlite 900® and Lewatit MP-62® are also used. The resins have functionalization by tertiary amino groups, but all of them have heterodisperse structures.

DE-A 19 958 390 discloses the use of monodisperse adsorbed resins, inter alia, for arsenic removal from aqueous solutions. However, these are not functionalized by amino/ammonium groups. It was therefore an object of the present invention first to provide ion exchangers that are suitable particularly for arsenic ions and/or for antimony ions and that remove arsenic ions and/or antimony ions selectively from reaction solutions during synthetic processes, and that function reliably even at relatively high temperatures over prolonged periods and thus permit water from process circulation systems to be released back into the environment.

Second, however, there is the environmental or health problem of removing arsenic compounds or antimony compounds as completely as possible from dilute aqueous solutions. Solutions of this type may be leachate water from slag heaps from mines or from metallurgical processes, leachate water from landfill sites, or washing solutions from waste incineration, or else process water from the electrical industry or from the chemical industry. The removal of the arsenic compounds and antimony compounds generally poses problems here, due to the amphoteric properties of the metalloids. In particular, the use of ion exchangers, which are otherwise a preferred means of removing low concentration ions, gives little success with arsenic compounds or with antimony compounds.

With the aid of the monodisperse amino/ammonium functionalized ion exchangers or monodisperse chelating resins according to the invention, it should generally be possible to remove arsenic and antimony from arsenic- and/or antimony-contaminated ground water or surface water to the extent that such water can be reintroduced into circulation in the environment.

Surprisingly, it has now been found that arsenic and/or antimony can be removed with high selectivity from aqueous solutions by using monodisperse anion exchangers that have been functionalized by amino groups or by ammonium groups, or using monodisperse chelating resins, as long as the arsenic compounds and the antimony compounds are converted in advance into hexafluoroarsenate ions and/or into hexafluoroantimonate ions. Since AsF₆⁻ ions and SbF₆⁻ ions are highly stable, they can be produced from oxidation state +3 by exposure to oxidants, such as fluorine, hydrogen peroxide, or other oxidants active in the presence of fluoride ions, starting from dissolved arsenic compounds or from dissolved antimony compounds. It is preferable for the arsenic compounds or the antimony compounds, in aqueous solutions, to be oxidized electrolytically in the presence of fluoride ions, and reacted to give AsF₆⁻ ions or SbF₆⁻ ions.

### SUMMARY OF THE INVENTION

The invention therefore provides a process for selective adsorption of arsenic ions and/or of antimony ions from aqueous solutions comprising treating aqueous solutions containing SbF₆⁻ ions or AsF₆⁻ ions with monodisperse anion exchangers or monodisperse chelating resins (particularly monodisperse amino/ammonium-functionalized anion exchangers or monodisperse chelating resins). If the arsenic or antimony compounds are not already present in the oxidation state +5, the compounds are converted oxidatively in advance into AsF₆⁻ ions or SbF₆⁻ ions, which are adsorbed from aqueous solutions, particularly preferably from aqueous solutions for which the pH is neutral or weakly alkaline or else acid.

### DETAILED DESCRIPTION OF THE INVENTION

The anionic exchangers or chelating resins to be employed according to the invention are in the form of monodisperse bead polymers and have been functionalized by primary or tertiary amino groups or by quaternary ammonium groups or by a mixture thereof or are monodisperse chelating resins, as disclosed in DE-A 19 940 866.

The anion exchangers or chelating resins to be used according to the invention must be monodisperse.

Substances that are monodisperse for the purposes of the present application are those in which the diameter of at least 90% of the particles, by volume or by weight, varies from the most frequent diameter by not more than ±10% of the most frequent diameter. For example, in the case of a bead polymer for which the most frequent bead diameter is 0.5 mm at least 90%, by volume or by weight, lie in the size range from 0.45 to 0.55 mm, and in the case of a bead polymer for which the most frequent bead diameter is 0.70 mm at least 90%, by weight or by volume, lie within the size range from 0.77 to 0.63 mm. The present invention provides the use of bead polymers for which the monodisperse property derives from the production process, i.e., bead polymers that can be obtained by jet techniques, seed/feed, or direct spraying. The latter production processes are described in U.S. Pat. Nos. 3,922,255, 4,444,961, and 4,427,794, for example.

The anion exchangers or chelating resins to be used according to the invention are composed of crosslinked polymers of singly ethylenically unsaturated monomers, mainly composed of at least one compound from the group consisting of styrene, vinyltoluene, ethylstyrene, α-methylstyrene, and ring-halogenated derivatives thereof, such as chlorostyrene. Besides these, the monomers may also include one or more compounds selected from the group consisting of vinylbenzyl chloride, acrylic acid, salts or esters thereof, in particular the methyl ester, and also vinylnaphthalenes, vinylxylenes, and the nitrites and amides of acrylic or methacrylic acids.

The polymers are crosslinked, preferably via copolymerization with crosslinking monomers having more than one, preferably two or three, copolymerizable carbon-carbon double bond(s) per molecule. Examples of crosslinking monomers of this type are polyfunctional vinylaromatics, such as di- or trivinylbenzene, divinylethylbenzene, divinyltoluene, divinylxylene, divinylethylbenzene, divinylnaphthalene, polyfunctional allylaromatics, such as di- or triallylbenzenes, polyfunctional vinyl- or allylheterocycles, such as trivinyl or triallyl cyanurate, or trivinyl or triallyl isocyanurate, N,N′-C₁-C₆-alkylenediacrylamides or dimethacrylamides, such as N,N′-methylenediacrylamide or -dimethacrylamide, N,N′-ethylenediacrylamide or -dimethacrylamide, polyvinyl or polyallyl ethers of saturated C₂-C₂₀ polyols having from 2 to 4 OH groups per molecule, for example, ethylene glycol divinyl ether or ethylene glycol diallyl ether, or diethylene glycol divinyl ether or diethylene glycol diallyl ether, esters of unsaturated C₃-C₁₂ alcohols or of saturated C₂-C₂₀ polyols having from 2 to 4 OH groups per molecule, for example, allyl methacrylate, ethylene glycol di(meth)acrylate, glycerol tri(meth)acrylate, pentaerythritol tetra(meth)acrylate, divinylethylene urea, divinylpropylene urea, divinyl adipate, and aliphatic or cycloaliphatic olefins having 2 or 3 isolated carbon-carbon double bonds, for example, 1,5-hexadiene, 2,5-dimethyl-1,5-hexadiene, 1,7-octadiene, or 1,2,4-trivinylcyclohexane. Monomers that have proven particularly successful as crosslinking monomers are divinylbenzene (in the form of an isomer mixture) and also mixtures made from divinylbenzene with aliphatic C₆-C₁₂ hydrocarbons having 2 or 3 carbon-carbon double bonds. The amounts generally used of the crosslinking monomers are from 1 to 80% by weight, preferably from 2 to 25% by weight, based on the total amount of the polymerizable monomers used.

The crosslinking monomers used need not be in pure form but may also be in the form of their industrially traded low-purity mixtures (e.g., divinylbenzene in a mixture with ethylstyrene).

The copolymerization of monomer and crosslinker is usually initiated by free-radical generators that are monomer-soluble. Preferred free-radical-generating catalysts include diacyl peroxides, such as diacetyl peroxide, dibenzoyl peroxide, di-p-chlorobenzoyl peroxide, and lauroyl peroxide, peroxyesters, such as tert-butyl peroxyacetate, tert-butyl peroctoate, tert-butyl peroxypivalate, tert-butylperoxy-2-ethylhexanoate, tert-butyl peroxybenzoate, and dicyclohexyl peroxydicarbonate, alkyl peroxides, such as bis(tert-butylperoxybutane), dicumyl peroxide, and tert-butyl cumyl peroxide, hydroperoxides, such as cumene hydroperoxide and tert-butyl hydroperoxide, ketone peroxides, such as cyclohexanone hydroperoxide, methyl ethyl ketone hydroperoxide and acetylacetone peroxide, and, preferably, azoisobutyrodinitrile.

The free-radical generators may be used in catalytic amounts, i.e., preferably from 0.01 to 2.5% by weight, in particular from 0.12 to 1.5% by weight, based on the total of monomer and crosslinker.

The water-insoluble monomers/crosslinker mixture is added to an aqueous phase that preferably comprises at least one protective colloid to stabilize the monomer/crosslinker droplets in the disperse phase and the resultant bead polymers. Preferred protective colloids are naturally occurring or synthetic water-soluble polymers, e.g., gelatin, starch, polyvinyl alcohol, polyvinylpyrrolidone, polyacrylic acid, polymethacrylic acid, or copolymers made from (meth)acrylic acid or from (meth)acrylic esters. Other very suitable materials are cellulose derivatives, in particular cellulose ethers or cellulose esters, for example, methylhydroxyethylcellulose, methylhydroxypropylcellulose, hydroxyethylcellulose, or carboxymethylcellulose. The amount used of the protective colloids is generally from 0.02 to 1% by weight, preferably from 0.05 to 0.3% by weight, based on the aqueous phase.

The ratio of aqueous phase to organic phase by weight is preferably in the range from 0.5 to 20, in particular from 0.75 to 5.

In one particular embodiment, the base polymers are prepared with a buffer system present during polymerization. Preference is given to buffer systems that set the pH of the aqueous phase at the start of the polymerization to a value of from 14 to 6, preferably from 12 to 8. Under these conditions, protective colloids having carboxylic acid groups are to some extent or entirely in the form of salts. This has an advantageous effect on the action of the protective colloids. The concentration of buffer in the aqueous phase, expressed as mmol per liter of aqueous phase, is preferably from 0.5 to 500, in particular from 2.5 to 100.

In order to prepare monodisperse bead polymers with very uniform particle size, the stream of monomer is injected into the aqueous phase, in which case the production of droplets of uniform size, without coalescence, is reliably provided by vibration-induced breakdown of the jet and/or by microencapsulation of the resultant monomer droplets (EP 46,535 B1 and EP 51,210 B1).

The polymerization temperature depends on the decomposition temperature of the initiator that is used but is generally from 50 to 150° C., preferably from 55 to 100° C. The polymerization takes from 0.5 hour to a few hours. It has proved useful to employ a temperature program in which the polymerization begins at a low temperature, e.g., 60° C., and the reaction temperature is raised as conversion in the polymerization progresses.

The resultant bead polymers may be passed to the functionalization process as they stand or else with enlarged particle size using an intermediate stage that can be approached by what is known as a seed/feed process. The steps of this seed/feed process comprise using copolymerizable monomers (“feed”) to initiate swelling of the polymer initially obtained (“seed”), and polymerizing the monomer which has penetrated into the polymer. Examples of suitable seed/feed processes are described in EP 98,130 B1, EP 101,943 B1 or EP 802,936 B1.

The ion exchangers may be microporous or gel-type or macroporous bead polymers.

The terms microporous, gel-type, and macroporous are known from the technical literature, for example, from Adv. Polymer Sci., Vol. 5, pages 113-213 (1967).

In order to give the monodisperse ion exchangers to be used according to the invention the macroporous structure, porogens, as described by way of example in Seidl et al., Adv. Polymer Sci., Vol. 5, pages 113-213 (1967), are added to the monomer/crosslinker mixture, examples of these being aliphatic hydrocarbons, alcohols, esters, ethers, ketones, trialkylamines, nitro compounds, and preferably hexane, octane, isooctane, isododecane, isodecane, methyl isobutyl ketone, or methyl isobutyl carbinol, in amounts of from 1 to 150% by weight, preferably from 40 to 100% by weight, in particular from 50 to 80% by weight, based on the total of monomer and crosslinker.

Macroporous bead polymers have pore diameters of about 50 Angstrom or greater.

The ion exchangers obtained without porogens have microporous or gel-type structure.

The actual anion exchangers or chelating resins to be used according to the invention for adsorption of AsF₆⁻ and/or of SbF₆⁻ are prepared by functionalizing the bead polymers.

An industrially practiced process for preparing monodisperse anion exchangers functionalized by amino groups and/or by ammonium groups or for preparing monodisperse chelating resins starting from bead polymers based on styrene and divinylbenzene (DVB) proceeds by first functionalizing (chloromethylating) the aromatic ring systems present in the bead polymers, followed by reaction with amines or, respectively, iminodiacetic acid or thiourea.

Preferred amines are trimethylamine, dimethylaminoethanol, triethylamine, tripropylamine, tributylamine, ammonia, Urotropin, and aminodiacetic acid. The products here are anion exchangers and, respectively, chelating resins with quaternary ammonium groups or with primary or secondary amino groups, such as aminomethyl groups, dimethylaminomethyl groups, trimethylaminomethyl groups, dimethylaminomethylhydroxyethyl groups, iminodiacetic acid groups, thiourea groups, or aminomethylphosphonic acid groups.

Bead polymers with aminomethyl groups may be reacted with chloroacetic acid to give ion exchangers with iminodiacetic acid groups or with formalin/phosphorus(3) compounds to give ion exchangers having aminomethylphosphonic acid groups.

Another industrially practiced process for preparing the anion exchangers and chelating resins to be used according to the invention for adsorption of AsF₆⁻ and/or SbF₆⁻, starting from bead polymers based on styrene and divinylbenzene (DVB), proceeds by reacting the aromatic ring systems present in the bead polymers with phthalimide derivatives, such as bis(phthalimidomethyl) ether, the SO₃ adduct of bis(phthalimidomethyl) ether, or N-acetoxymethylphthalimide, followed by other reactive steps, to give anion exchangers of varying basicity or chelating resins (see, for example, U.S. Pat. No. 3,989,650 or EP-A 46,535 B1).

However, it is also possible to use macroporous or gel-type monodisperse anion exchangers based on acrylic esters to remove the arsenic-containing and/or antimony-containing anions. Crosslinked, monodisperse bead polymers based on acrylic esters are reacted with polyamines, e.g., N,N-dimethyl-1,3-propylenediamine, with amide formation. The product here is a weakly basic anion exchanger that may be reacted with chloromethane, for example, to give strongly basic anion exchangers (see, for example, Ullmann's Encyclopedia of Industrial Chemistry, Vol. A 14, p. 398).

The practical work carried out in connection with the present invention has shown that monodisperse ion exchangers that contain quaternary ammonium groups are preferably suitable for adsorption from neutral or weakly alkaline aqueous solutions. For adsorption from acid solutions, ion exchangers having quaternary ammonium groups and those having tertiary or primary amino groups or mixtures of the same are both suitable. For selectivity of adsorption of AsF₆⁻, and of SbF₆⁻, preference is given to anion exchangers having tertiary amino groups.

Since AsF₆⁻ ions and SbF₆⁻ ions give particularly good adsorption, it is advisable to convert all of the arsenic ions and antimony ions to be adsorbed in the adsorption media to hexafluoroarsenic acid or HSbF₆ or compounds thereof, preferably to salts of hexafluoroacetic acid or HSbF₆, particularly preferably to the sodium or potassium salt of a hexafluoroarsenic acid or HSbF₆, which are particularly preferably adsorbed on the ion exchangers to be used according to the invention.

The particularly advantageous hydrodynamic properties of monodisperse anion exchangers and of monodisperse chelating resins thus permit process water from the electrical industry, particularly from the semiconductor industry, or from the chemical industry to be purified with respect to contamination by arsenic or antimony, particularly when very dilute solutions of these metalloids, or of their salts, are involved.

The following example further illustrates details for the process of this invention. The invention, which is set forth in the foregoing disclosure, is not to be limited either in spirit or scope by this example. Those skilled in the art will readily understand that known variations of the conditions of the following procedure can be used. Unless otherwise noted, all temperatures are degrees Celsius and all percentages are percentages by weight.

### EXAMPLE

20 liters of leachate water with 3.5 ppm of As were treated with 2.8 g of 40% strength HF and 10 ml of H₂O₂ solution. The liquid was then passed through an ion exchanger column packed with Lewatit® VPOC 1094, a monodisperse resin based on styrene/divinylbenzene with 25% quaternary ammonium groups and 75% tertiary amino groups. The arsenic content of the eluent was determined as <0.05 ppm of arsenic per liter of liquid.

What is claimed is:

1. A process for selective adsorption of arsenic ions and/or of antimony ions from aqueous solutions comprising treating an aqueous solution containing SbF₆⁻ ions or AsF₆⁻ ions with a monodisperse anion exchanger or monodisperse chelating resin.

2. A process according to claim 1 wherein the monodisperse anion exchanger or monodisperse chelating resin has been functionalized with quaternary ammonium groups, with tertiary or primary amino groups, or with a mixture thereof.

3. A process according to claim 1 wherein the monodisperse anion exchanger or monodisperse chelating resin is macroporous, gel-type, or microporous.

4. A process according to claim 1 wherein the monodisperse anion exchanger or chelating resin is composed of bead polymers based on unsaturated monomers selected from the group consisting of styrene, vinyltoluene, α-methylstyrene, and ring-halogenated derivatives thereof or based on acrylic materials.

5. A process according to claim 1 wherein an arsenic compound or antimony compound in an oxidation state other than +5 is first converted oxidatively into AsF₆⁻ ions or SbF₆⁻ ions.

6. A process according to claim 1 wherein the adsorption of the SbF₆⁻ ions and/or AsF₆⁻ ions takes place from a neutral, acid, or weakly alkaline aqueous solution.

7. A process according to claim 1 wherein the aqueous solution containing SbF₆⁻ ions or AsF₆⁻ ions is water from a process circulation system or is ground or surface water.

8. A process according to claim 2 wherein the aqueous solution containing SbF₆⁻ ions or AsF₆⁻ ions is process water for the electrical industry or chemical industry, leachate water, or aqueous washing solutions.
